(19) United States
(12) Patent Application Publication
(10) Pub. No.: US 2025/0171070 A1
(43) Pub. Date: May 29, 2025

(54) STEERING DEVICE

(71) Applicant: TOYODA GOSEI CO., LTD., Kiyosu-shi (JP)

(72) Inventor: Itsuhiko HIROTA, Kiyosu-shi (JP)

(21) Appl. No.: 18/946,511

(22) Filed: Nov. 13, 2024

(30) Foreign Application Priority Data
Nov. 28, 2023 (JP) 2023-200316

(51) Int. Cl. B62D 1/04

(52) U.S. Cl. CPC B62D 1/046

(57) ABSTRACT

A steering device comprises: a rotary part rotatably attached to the vehicle; and a peripheral part on both sides of a rotary axis of the rotary part. The peripheral part is connected to the rotary part. The rotary part includes illuminators to emit light rays toward a predetermined portion in the peripheral part. The illuminators are configured in such a manner that respective optical axes pass through places included in the predetermined portion and located on one plane containing a perpendicular direction and a rightward-leftward direction of the vehicle. The perpendicular direction is perpendicular to (i) a rotary axis direction as a direction along the rotary axis of the vehicle and (ii) the rightward-leftward direction of the vehicle. When viewed in the rightward-leftward direction of the vehicle, all the plurality of light illuminators are arranged on the same side with respect to the plane.

### BACKGROUND

### Field

The present disclosure relates to a steering device.

The present application claims the priority based on Japanese Patent Application No. 2023-200316 filed on Nov. 28, 2023, the disclosure of which is hereby incorporated by reference in its entirety.

### Related Art

Japanese Patent Application Publication No. 2018-111440 discloses a steering wheel illumination device to emit visible light rays to a wheel of a steering of a vehicle using a plurality of light-emitting parts mounted on a pad part and a spoke part of the steering. These light-emitting parts emit light rays toward an upward direction of the vehicle from the pad part and the spoke part.

Japanese Patent Application Publication No. 2018-111440 does not specifically show a location of the light-emitting part at the pad part or the spoke part. It is generally believed that intensity of each portion of a light ray becomes higher as the portion gets closer to an optical axis and becomes lower as the portion gets farther from the optical axis. It is probable that, depending on the positions of the plurality of light-emitting parts at the pad part or the spoke part, the wheel will not be illuminated uniformly with light rays from the plurality of light-emitting parts when a passenger sees the wheel. In this case, non-uniformity in brightness might occur between parts of the wheel visually recognized by a driver. This leaves room for improvement in the appearance of a wheel of a steering including a plurality of light-emitting parts.

### SUMMARY

The present disclosure is feasible in the following aspects.

According to one aspect of the present disclosure, a steering device mounted on a moving object is provided. The steering device comprises: a rotary part rotatably attached to the moving object; and a peripheral part arranged at least on both sides of a rotary axis of the rotary part. The peripheral part is connected to the rotary part. The rotary part includes a plurality of light illuminators to emit light rays toward a predetermined portion in the peripheral part. The plurality of light illuminators is configured in such a manner that respective optical axes of light rays emitted from the plurality of light illuminators pass through places included in the predetermined portion and located on one plane containing a perpendicular direction and a rightward-leftward direction of the moving object. The perpendicular direction is perpendicular to a rotary axis direction as a direction along the rotary axis of the moving object and to the rightward-leftward direction of the moving object. When viewed in the rightward-leftward direction of the moving object, all the plurality of light illuminators are arranged on the same side with respect to the plane.

### BRIEF DESCRIPTION OF THE DRAWINGS

FIG. 1 is an explanatory view of a vehicle provided with a steering device according to a present embodiment;

FIG. 2 is a view explaining the steering device;

FIG. 3 is a view corresponding to FIG. 2 taken from a different angle;

FIG. 4 is a view showing light rays emitted from a first light illuminator and a second light illuminator;

FIG. 5 is a view showing only a rotary case unit;

FIG. 6 is a view explaining the first light illuminator and the second light illuminator;

FIG. 7 is a view of the steering device taken in a-Y direction;

FIG. 8 is a sectional view along VIII-VIII in FIG. 2;

FIG. 9 is a view showing the first light illuminator in FIG. 8 in an enlarged manner; and

FIG. 10 is a view explaining layout of light-emitting elements of the first light illuminator and light-emitting elements of the second light illuminator according to the present embodiment.

### DETAILED DESCRIPTION

### A. Present Embodiment

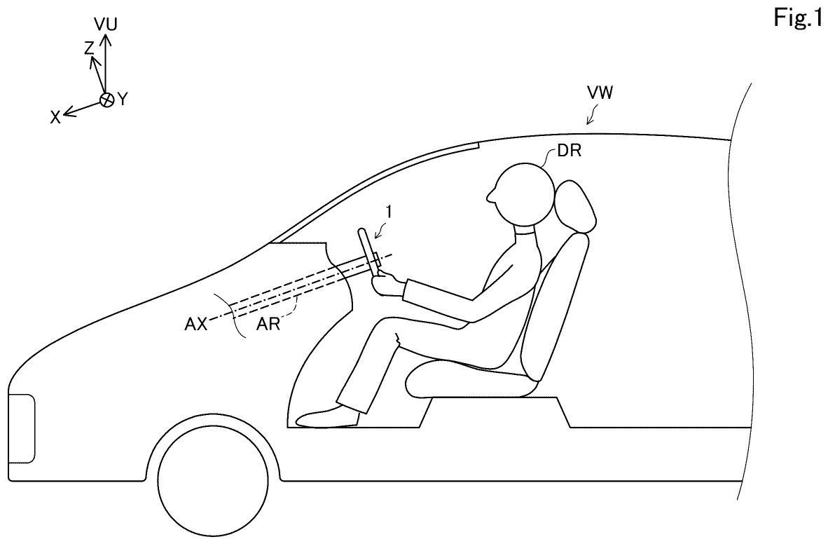

FIG. 1 is an explanatory view of a vehicle VW mounted with a steering device 1 according to a present embodiment. FIG. 1 shows the steering device 1 in a simplified manner. As shown in FIG. 1, in the present embodiment, the steering device 1 is mounted on the vehicle VW as a moving object. The steering device 1 is a device to be operated by a driver DR who is a passenger of the vehicle VW. The steering device 1 is coupled to a rotary axis AR of the vehicle VW and is configured to be operable to rotate about an axis line AX of the rotary axis AR. The rotation of the steering device 1 is transmitted via the rotary axis AR to a steering gear box not shown in the drawings. A direction along the axis line AX of the rotary axis AR is denoted as an X direction. A direction of getting away from the driver DR is denoted as a +X direction. Of directions perpendicular to the axis line AX, a direction conforming to a rightward-leftward direction of the vehicle VW is denoted as a Y direction. A direction conforming to a direction toward a rightward direction of the vehicle VW is denoted as a +Y direction. A direction conforming to a direction toward a leftward direction of the vehicle VW is denoted as a −Y direction. A direction perpendicular to the axis line AX and to the Y direction is denoted as a Z direction. In FIG. 1, a way in which a vertical direction is pointed is represented by a VU axis. An upward pointing of the vertical direction is a positive direction of the VU axis.

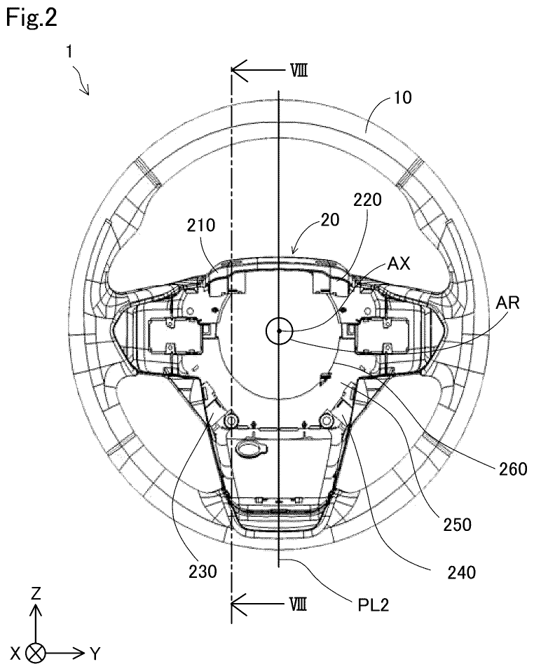

FIG. 2 is a view explaining the steering device 1. The steering device 1 shown in FIG. 2 is in a state of not rotating relative to the vehicle VW. In FIG. 2, the rotary axis AR and the steering device 1 seem not to be coupled to each other. However, a fixing unit of the steering device 1 not shown in the drawings and the rotary axis AR are coupled to each other and the fixing unit is coupled to a peripheral part 10 and a rotary part 20 forming the steering device 1. The steering device 1 includes the peripheral part 10 and the rotary part 20.

The peripheral part 10 is located in a periphery of the rotary part 20 described later. The peripheral part 10 is a part to be gripped by the driver DR. In the present embodiment, the peripheral part 10 has a substantially ring-like shape when viewed in the X direction. The peripheral part 10 is arranged on both sides of the rotary axis AR. The peripheral part 10 is connected to the rotary part 20 on an inner peripheral side of the peripheral part 10. The peripheral part 10 covers a part of the rotary part 20. In this way, the peripheral part 10 becomes connected to the rotary part 20.

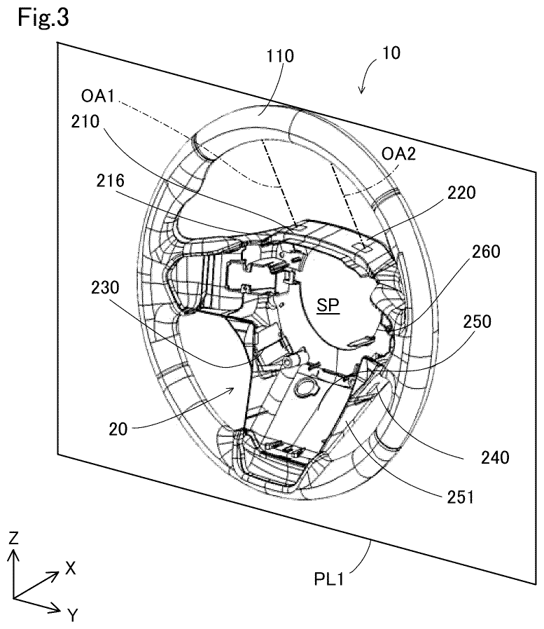

FIG. 3 is a view corresponding to FIG. 2 taken from a different angle. The rotary part 20 is rotatably attached to the vehicle VW. When the fixing unit connected to the peripheral part 10 rotates, the rotary part 20 rotates in conjunction with the fixing unit. As shown in FIG. 3, the rotary part 20 has a shape projecting toward the +X direction. As shown in FIG. 3, the rotary part 20 being at an angular position of instructing a forward direction as a traveling direction to the vehicle VW is denoted as “the rotary part 20 being at a reference angular position.” As shown in FIGS. 2 and 3, the rotary part 20 includes a first light illuminator 210, a second light illuminator 220, a third light illuminator 230, a fourth light illuminator 240, a rotary case unit 250, a rotary hole part 260, and housing space SP.

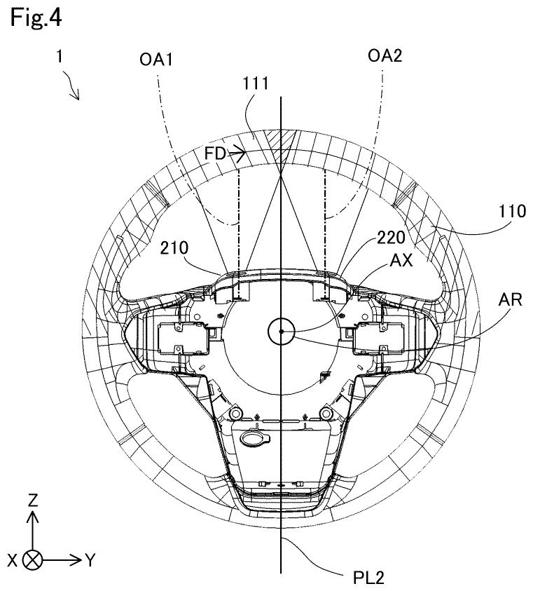

FIG. 4 is a view showing light rays emitted from the first light illuminator 210 and the second light illuminator 220. As shown in FIG. 4, the first light illuminator 210 emits a light ray toward a predetermined portion 110 in the peripheral part 10. The predetermined portion 110 in the peripheral part 10 means a place located in a predetermined direction with respect to the axis line AX of the rotary axis AR when the steering device 1 is viewed in the +X direction. The predetermined direction means any one of the above-described +Y direction, the above-described-Y direction, a +Z direction, and a −Z direction, or any one of a direction between the +Y direction and the +Z direction, a direction between the +Y direction and the −Z direction, a direction between the −Y direction and the +Z direction, and a direction between the −Y direction and the −Z direction. The predetermined direction differs in response to the shape of the peripheral part 10 or the rotary part 20. In the present embodiment, as shown in FIG. 4, the predetermined portion 110 is a place in the peripheral part 10 located closer to the +Z direction than the axis line AX of the rotary axis AR when the steering device 1 is viewed in the +X direction. In FIG. 4, the predetermined portion 110 is hatched.

A light ray emitted from the first light illuminator 210 toward the predetermined portion 110 in the peripheral part 10 does not illuminate the predetermined portion 110 in the peripheral part 10 entirely. As shown in FIG. 4, the light ray emitted from the first light illuminator 210 illuminates a part 111 of the predetermined portion 110 in the peripheral part 10.

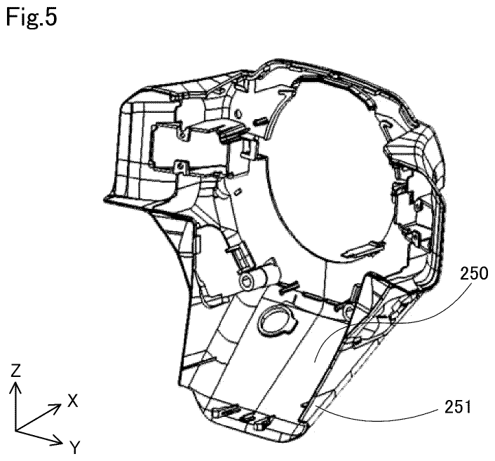

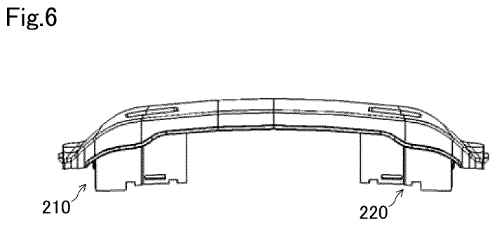

FIG. 5 is a view showing only the rotary case unit 250. FIG. 6 is a view explaining the first light illuminator 210 and the second light illuminator 220. As shown in FIGS. 3, 5, and 6, a part of the first light illuminator 210 forms a surface continuous with an outer surface 251 belonging to a surface of the rotary case unit 250 and facing the peripheral part 10. The first light illuminator 210 is configured to be attachable to and detachable from the rotary case unit 250. In the present embodiment, the first light illuminator 210 is engaged with the rotary case unit 250 to be fixed to the rotary case unit 250. The first light illuminator 210 is engaged with the second light illuminator 220.

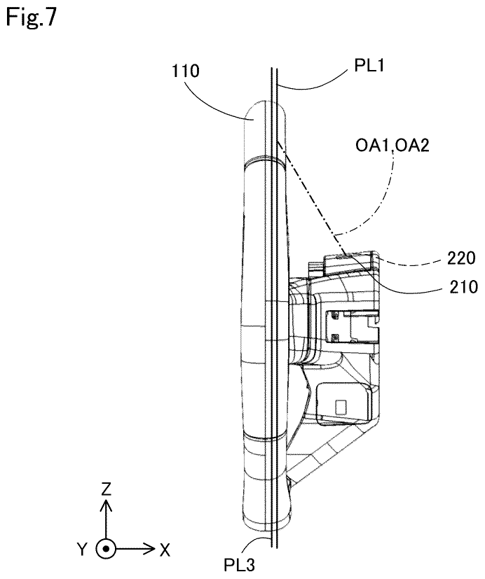

FIG. 7 is a view of the steering device 1 taken in the-Y direction. As shown in FIGS. 3 and 7, the first light illuminator 210 is configured in such a manner that a first optical axis OA1 as an optical axis of the first light illuminator 210 passes through a place included in the predetermined portion 110 and located on a first plane PL1 containing the Z direction and the Y direction. The Z direction is a direction perpendicular to the X direction as a direction along the axis line AX of the rotary axis AR and to the Y direction as the rightward-leftward direction of the vehicle VW. The X direction is also denoted as a rotary axis direction. A statement that an optical axis passes through a place on the first plane means that a light ray along the optical axis is incident on the place included in the predetermined portion 110 and located on the first plane. This statement does not cover a situation where an extension of the optical axis incident on the peripheral part 10 passes through the place on the first plane.

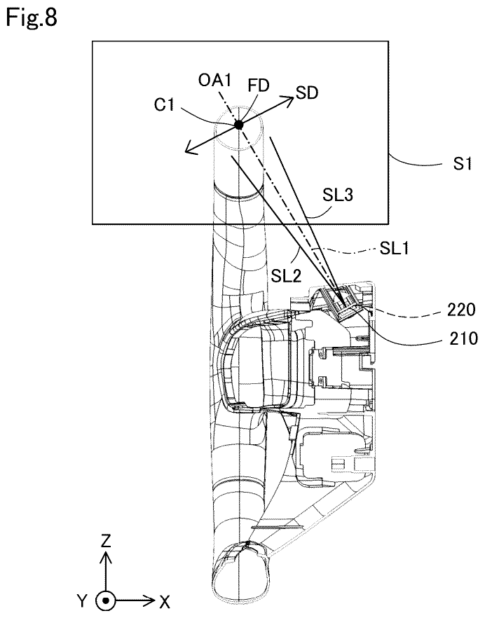

FIG. 8 is a sectional view along VIII-VIII in FIG. 2. Hatching is omitted from FIG. 8. In the following, as shown in FIG. 4, a direction in which the predetermined portion 110 in the peripheral part 10 extends will be denoted as a first direction FD. A direction perpendicular to the first direction FD and to the first optical axis OA1 will be denoted as a second direction SD. As shown in FIG. 8, the steering device of the present embodiment is configured in such a manner that the first optical axis OA1 passes through a center C1 of a section at the peripheral part 10 on a plane S1 containing the second direction SD and the first optical axis OA1. As shown in FIG. 8, in the present embodiment, two sections of the peripheral part 10 are juxtaposed in the Z direction. A statement in the present specification that X is configured in such a manner that an optical axis passes through a center of a section at the peripheral part 10 means that X is configured in such a manner that the optical axis passes through a center of one of the sections. A statement in the present specification that an optical axis passes through a center of a section at the peripheral part 10 on the plane containing the second direction and the optical axis means that an extension of the optical axis incident on the peripheral part 10 passes through the center of the section at the peripheral part 10 on the plane containing the second direction and the optical axis. This statement also means that, with respect to a straight line along which the optical axis passes through the center of the section at the peripheral part 10, the optical axis falls in an angular range of 10° from the straight line on the plane containing the second direction and the optical axis. In the present embodiment, with respect to a straight line SL1 shown in FIG. 8, the first optical axis OA1 falls within an angular range of 10° expressed by straight lines SL2 and SL3 on the plane S1 containing the second direction SD and the first optical axis OA1.

As shown in FIG. 4, the steering device of the present embodiment is configured in such a manner that the first optical axis OA1 of a light ray from the first light illuminator 210 is parallel to a second plane PL2 when the rotary part 20 is at the reference angular position. The second plane PL2 is a plane containing the X direction and the Z direction.

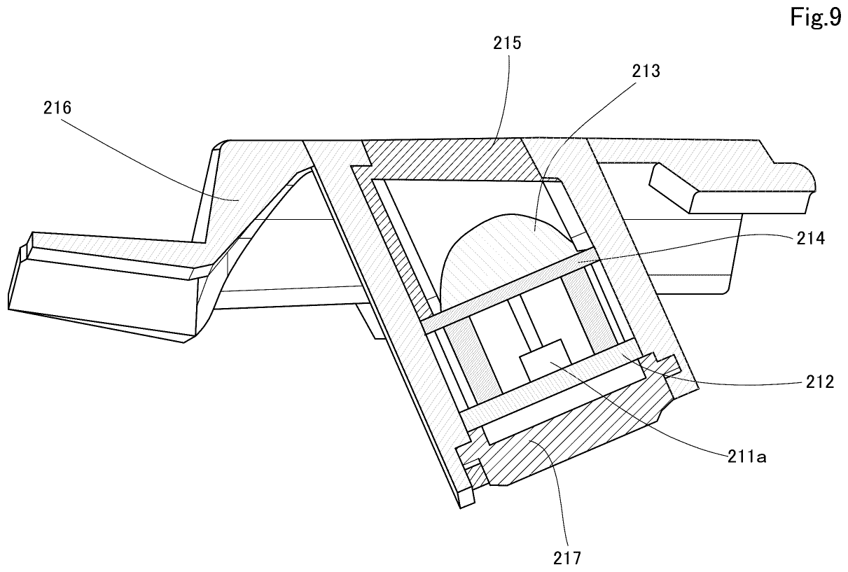

FIG. 9 is a view showing the first light illuminator 210 in FIG. 8 in an enlarged manner. Illustration of a part of the steering device 1 is omitted from FIG. 9. The first light illuminator 210 includes a first light-emitting element 211a, a second light-emitting element 211b, a third light-emitting element 211c, a substrate 212, a lens 213, a lens mount 214, a lens cover 215, a cover 216, a bottom wall unit 217, and a connector 218. Illustrations of the second light-emitting element 211b, the third light-emitting element 211c, and the connector 218 are omitted from FIG. 9.

The first light-emitting element 211a, the second light-emitting element 211b, and the third light-emitting element 211c emit light rays of colors differing from each other. The first light-emitting element 211a emits a light ray of red. The second light-emitting element 211b emits a light ray of green. The third light-emitting element 211c emits a light ray of blue. A controller of the steering device 1 not shown in the drawings exerts control to determine which one of the first light-emitting element 211a, the second light-emitting element 211b, and the third light-emitting element 211c is to emit a light ray. In the present embodiment, the first light-emitting element 211a to the third light-emitting element 211c are arranged in such a manner that respective optical axes of light rays emitted from the first light-emitting element 211a, the second light-emitting element 211b, and the third light-emitting element 211c are included in the first plane PL1. In the present embodiment, light-emitting diodes are used as the first light-emitting element 211a to the third light-emitting element 211c.

The first light-emitting element 211a to the third light-emitting element 211c are placed on the substrate 212. In the present embodiment, the substrate 212 is a printed board. The lens 213 converges light rays emitted from the first light-emitting element 211a to the third light-emitting element 211c. The lens 213 is mounted on the lens mount 214. The lens cover 215 transmits a light ray therethrough having been passed through the lens 213. The cover 216 houses the first light-emitting element 211a to the third light-emitting element 211c, the substrate 212, the lens 213, the lens mount 214, and the lens cover 215, and is engaged with the rotary case unit 250. The bottom wall unit 217 is engaged with the cover 216, thereby keeping the first light-emitting element 211a to the third light-emitting element 211c, the substrate 212, the lens 213, the lens mount 214, and the lens cover 215 housed in the cover 216. When an operator releases the engagement between the bottom wall unit 217 and the cover 216, the first light-emitting element 211a to the third light-emitting element 211c, the substrate 212, the lens 213, the lens mount 214, and the lens cover 215 become detachable from the cover 216. The connector 218 is electrically connected to the controller of the steering device 1 via a cable not shown in the drawings.

The second light illuminator 220 shown in FIG. 4 emits a light ray toward the predetermined portion 110 in the peripheral part 10. The second light illuminator 220 has the same configuration as the first light illuminator 210. The second light illuminator 220 is controlled by the controller in such a manner as to emit a light ray of the same color as a light ray emitted from the first light illuminator 210 and to emit a light ray with timing coinciding with timing of emission of a light ray from the first light illuminator 210. A difference of the second light illuminator 220 from the first light illuminator 210 will be described below. As shown in FIGS. 3 and 8, when viewed in the Y direction, the second light illuminator 220 is arranged on the +X direction side with respect to the first plane PL1, which is the same side as the first light illuminator 210. The second light illuminator 220 is arranged at a different position from the first light illuminator 210 with respect to the rotary case unit 250. The second light illuminator 220 is configured to be symmetric to the first light illuminator 210 with respect to the second plane PL2 when the rotary part 20 is at the reference angular position. As shown in FIG. 6, the second light illuminator 220 is engaged with the first light illuminator 210. While the second light illuminator 220 is engaged with the first light illuminator 210, the second light illuminator 220 becomes engaged with the rotary case unit 250 by an operator.

The second light illuminator 220 is arranged at a different position from the first light illuminator 210. Thus, as shown in FIG. 4, a place in the peripheral part 10 on which a light ray emitted from the second light illuminator 220 mainly impinges is not the same as a place in the peripheral part 10 on which a light ray emitted from the first light illuminator 210 impinges. As shown in FIG. 4, of a light ray emitted from the second light illuminator 220, a large proportion of the emitted light ray impinges on a place closer to the +Y direction than a place at the steering device 1 on which a light ray emitted from the first light illuminator 210 impinges when the steering device 1 is viewed in the +X direction.

The second light illuminator 220 is configured in such a manner that a second optical axis OA2, which is an optical axis of a light ray emitted from the second light illuminator 220, passes through a place included in the predetermined portion 110 and located on the same plane as the first plane PL1 (see FIGS. 3 and 7). Specifically, the first light illuminator 210 and the second light illuminator 220 are configured in such a manner that the first optical axis OA1 and the second optical axis OA2 pass through places on the first plane PL1 as one plane. Passing of an optical axis through a place on the first plane as the one plane means that a light ray along the optical axis is incident on the place on the first plane. In FIG. 7, the second optical axis OA2 overlaps the first optical axis OA1. A statement in the present specification that “respective optical axes of light rays emitted from a plurality of light illuminators pass through places included in the predetermined portion in the peripheral part 10 and located on one plane containing a perpendicular direction and a rightward-leftward direction of a moving object” means the following. Specifically, this statement means that, when viewed in the Y direction, of planes each containing the Z direction and the Y direction, (a) a plane containing a place in the peripheral part 10 on which one optical axis is incident and (b) a plane containing a place in the peripheral part 10 on which a different optical axis is incident are spaced by a gap that is within a range of 10% of a dimension in the X direction at the place in the peripheral part 10 on which the one optical axis is incident. As an example, a plane containing a place in the peripheral part 10 on which an optical axis of an imaginary light illuminator is incident is represented as a third plane PL3. If a gap between the third plane PL3 and the first plane PL1 is within a range of 10% of a dimension in the X direction at the place in the peripheral part 10 on which the first optical axis OA1 is incident, this case belongs to a case of being located on the one plane.

While not shown in the drawings, in the present embodiment, the second light illuminator 220 is configured in such a manner that the second optical axis OA2 passes through a center of a section at the peripheral part 10 on a plane containing a direction and the second optical axis OA2. This direction is perpendicular to a direction in which the predetermined portion 110 in the peripheral part 10 extends and to the second optical axis OA2. As shown in FIG. 4, in the present embodiment, the second light illuminator 220 is configured in such a manner that the second optical axis OA2 is parallel to the second plane PL2. The first optical axis OA1 is also parallel to the second plane PL2, as described above. This makes the second optical axis OA2 parallel to the first optical axis OA1 when viewed in the +X direction.

As shown in FIG. 4, in the present embodiment, a part of a light ray emitted from the first light illuminator 210 and a part of a light ray emitted from the second light illuminator 220 overlap each other. The first light illuminator 210 and the second light illuminator 220 are configured in such a manner that, when the rotary part 20 is at the reference angular position, the overlapping light rays impinge on a place included in the peripheral part 10 and located on an upper side in the vertical direction with respect to the rotary part 20 (see hatching in FIG. 4). In the present specification, “an upper side in the vertical direction with respect to the rotary part 20” means a region above a region occupied by the rotary part 20 in terms of the vertical direction. The presence of one object A “on an upper side in the vertical direction with respect to the rotary part 20” does not mean that the object A is directly above the rotary part 20 in the vertical direction. Specifically, in a view projected in the vertical direction, the position of the object A in a horizontal direction may not have to overlap the rotary part 20. Likewise, in the present specification, “a lower side in the vertical direction with respect to the rotary part 20” means a region below a region occupied by the rotary part 20 in terms of the vertical direction. The presence of one object A “on a lower side in the vertical direction with respect to the rotary part 20” does not mean that the object A is directly below the rotary part 20 in the vertical direction. Specifically, in a view projected in the vertical direction, the position of the object A in the horizontal direction may not have to overlap the rotary part 20.

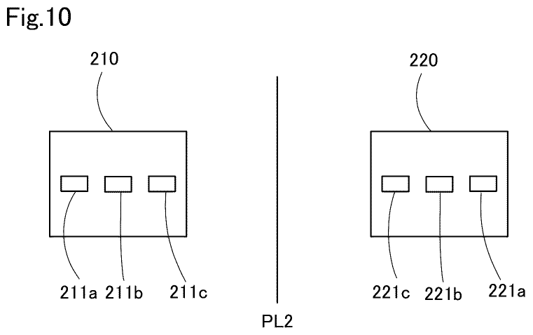

FIG. 10 is a view explaining layout of the light-emitting elements of the first light illuminator 210 and light-emitting elements of the second light illuminator 220 according to the present embodiment. The second light illuminator 220 has the same configuration as the first light illuminator 210 as described above, and includes a first light-emitting element 221a, a second light-emitting element 221b, and a third light-emitting element 221c. In the present embodiment, when the rotary part 20 is at the reference angular position, of the respective three light-emitting elements of the first light illuminator 210 and the second light illuminator 220, light-emitting elements to emit light rays of the same color are arranged symmetric to each other with respect to the second plane PL2. More specifically, the first light-emitting element 211a of the first light illuminator 210 and the first light-emitting element 221a of the second light illuminator 220 to emit light rays of red are arranged symmetric to each other with respect to the second plane PL2. The second light-emitting element 211b of the first light illuminator 210 and the second light-emitting element 221b of the second light illuminator 220 to emit light rays of green are arranged symmetric to each other with respect to the second plane PL2. The third light-emitting element 211c of the first light illuminator 210 and the third light-emitting element 221c of the second light illuminator 220 to emit light rays of blue are arranged symmetric to each other with respect to the second plane PL2.

In the present embodiment, the first light illuminator 210 and the second light illuminator 220 are configured in such a manner that respective optical axes of light rays from light-emitting elements to emit light rays of the same color pass through places in the peripheral part 10 on the first plane PL1. The first light illuminator 210 and the second light illuminator 220 are configured in such a manner that the first optical axis OA1 of a light ray emitted from the first light-emitting element 211a of the first light illuminator 210 and the second optical axis OA2 of a light ray emitted from the first light-emitting element 221a of the second light illuminator 220 pass through places in the peripheral part 10 on the first plane PL1. Likewise, the first light illuminator 210 and the second light illuminator 220 are configured in such a manner that the first optical axis OA1 of a light ray emitted from the second light-emitting element 211b of the first light illuminator 210 and the second optical axis OA2 of a light ray emitted from the second light-emitting element 221b of the second light illuminator 220 pass through places in the peripheral part 10 on the first plane PL1. Likewise, the first light illuminator 210 and the second light illuminator 220 are configured in such a manner that the first optical axis OA1 of a light ray emitted from the third light-emitting element 211c of the first light illuminator 210 and the second optical axis OA2 of a light ray emitted from the third light-emitting element 221c of the second light illuminator 220 pass through places in the peripheral part 10 on the first plane PL1.

The third light illuminator 230 shown in FIG. 2 emits a light ray toward a portion in the peripheral part 10 other than the predetermined portion 110. More specifically, when the steering device 1 is viewed in the +X direction, the third light illuminator 230 emits a light ray toward a portion in the peripheral part 10 located between the −Y direction and the −Z direction with respect to the axis line AX of the rotary axis AR. The third light illuminator 230 has a similar configuration to the first light illuminator 210. The third light illuminator 230 includes a cover having a shape differing from the shape of the cover 216 of the first light illuminator 210. The fourth light illuminator 240 emits a light ray toward a portion in the peripheral part 10 other than the predetermined portion 110. More specifically, when the steering device 1 is viewed in the +X direction, the fourth light illuminator 240 emits a light ray toward a portion in the peripheral part 10 located between the +Y direction and the −Z direction with respect to the axis line AX of the rotary axis AR. The fourth light illuminator 240 has a similar configuration to the first light illuminator 210. The fourth light illuminator 240 includes a cover having a shape differing from the shape of the cover 216 of the first light illuminator 210.

The rotary case unit 250 shown in FIG. 1 defines an outer shape of the rotary part 20 together with the first light illuminator 210. The rotary case unit 250 is engaged with the first light illuminator 210. The rotary hole part 260 forms a hole for passing the rotary axis AR therethrough. The housing space SP houses a part of the first light illuminator 210, an ECU for controlling the steering device 1, an airbag, and others. The parts such as the ECU and the airbag are not shown in the drawings.

In the steering device 1 of the present embodiment, a light ray emitted from each of the first light illuminator 210 and the second light illuminator 220 is incident on a place in the peripheral part 10 located in a predetermined direction with respect to the rotary part 20. The first light illuminator 210 and the second light illuminator 220 are configured in such a manner that the first optical axis OA1 and the second optical axis OA2 of a plurality of light illuminators pass through places included in the predetermined portion and located on the first plane PL1 as one plane containing the perpendicular direction and a rightward-leftward direction of a moving object. When viewed in the rightward-leftward direction of the moving object, the first light illuminator 210 and the second light illuminator 220 are arranged on the same side with respect to the first plane PL1. In comparison to a case where respective optical axes of a plurality of light illuminators do not pass through places located on one plane containing a direction perpendicular to the rotary axis AR of the moving object and to the rightward-leftward direction of the moving object, and the rightward-leftward direction of the moving object, or a case where one light illuminator is arranged on the right side with respect to the one plane and another light illuminator is arranged on the left side with respect to the one plane when viewed in the rightward-leftward direction of the moving object, for example, it is possible to reduce non-uniformity in brightness at the peripheral part 10 visually recognized when the driver DR sees the steering device 1 in a direction along the rotary axis AR.

Generally, in a light illuminator including a plurality of light-emitting elements, the respective locations of these light-emitting elements on a substrate are determined in various ways depending on the number of the light-emitting elements or the size of the substrate. Depending on the location of an electrical wire to be connected to the light illuminator or a position available for locating the light illuminator, for example, it is probable that optical axes of light-emitting elements belonging to a plurality of such light illuminators and to emit light rays of the same color will not pass through one plane containing (i) a direction perpendicular to the rotary axis AR of the vehicle VW and to the rightward-leftward direction of the vehicle VW, and (ii) the rightward-leftward direction of the vehicle VW. The optical axes of the light-emitting elements to emit light rays of the same color might be included in the same flat plane containing the rightward-leftward direction of the vehicle by causing total reflection of a light ray emitted from a light-emitting element and changing the direction of an optical axis of the light ray emitted from the light-emitting element using a lens, for example. This requires effort in defining the shape of the lens.

The steering device 1 of the present embodiment is configured in such a manner that light-emitting elements belonging to the first light illuminator 210 and the second light illuminator 220 respectively and to emit light rays of the same color are symmetric to each other with respect to the second plane PL2, and respective optical axes pass through the first plane PL1. This allows the first optical axis OA1 and the second optical axis OA2 to pass through places included in the predetermined portion 110 and located on the first plane PL1 as one plane containing the perpendicular direction and a rightward-leftward direction of a moving object. Thus, it is possible to reduce non-uniformity in brightness at the peripheral part 10 visually recognized by the driver DR without changing the direction of an optical axis of a light ray emitted from a light-emitting element by making effort in defining the shape of the lens 213, for example.

Generally, the dimension of the peripheral part 10 of the steering device 1 is smaller in a forward-backward direction of the vehicle VW than in the rightward-leftward direction of the vehicle VW. For this reason, it is probable that, if a light ray is emitted to the peripheral part 10 from a light illuminator capable of illuminating the peripheral part 10 in a certain range or more in the rightward-leftward direction of the vehicle VW, the light ray will pass through space outside the peripheral part 10 in terms of a direction parallel to the rotary axis AR viewed in a forward-backward direction of the peripheral part 10. Furthermore, it is generally believed that intensity of each portion of a light ray becomes higher as the portion gets closer to an optical axis and becomes lower as the portion gets farther from the optical axis. Hence, passing of a light ray close to an optical axis through the peripheral part 10 may cause a situation where the light ray emitted from a light illuminator will not be used efficiently. In the steering device 1 of the present embodiment, an optical axis passes through a center of a section at the peripheral part 10 on the plane containing the optical axis and the second direction. By doing so, when viewed in the forward-backward direction of the peripheral part 10, a light ray of high intensity is incident on the peripheral part 10 efficiently. This makes it possible to efficiently use light rays emitted from the first light illuminator 210 and the second light illuminator 220.

The steering device 1 of the present embodiment is configured in such a manner that overlapping light rays impinge on a place included in the peripheral part 10 and located on an upper side in the vertical direction with respect to the rotary part 20.

Thus, a light ray incident on the peripheral part 10 is visually recognized easily by the driver DR.

In the steering device 1 of the present embodiment, in comparison to a case where the rotary part 20 is at the reference angular position, the second optical axis OA2 of the second light illuminator 220 is tilted from the second plane PL2 toward the rightward direction of the vehicle VW, and the first optical axis OA1 of the first light illuminator 210 is tilted from the second plane PL2 toward a leftward direction of the vehicle VW when the steering device 1 is viewed in the +X direction, for example, proportions of overlapping light rays are increased. In the steering device 1 of the present embodiment, in comparison to a configuration where the first optical axis OA1 and the second optical axis OA2 are not parallel to the second plane PL2, a light ray incident on the peripheral part 10 is visually recognized easily by the driver DR in a place included in the peripheral part 10 and located on an upper side in the vertical direction with respect to the rotary part 20.

In comparison to a case where the first optical axis OA1 of the first light illuminator 210 is tilted from the second plane PL2 toward the rightward direction of the vehicle VW, the second optical axis OA2 of the second light illuminator 220 is tilted from the second plane PL2 toward the leftward direction of the vehicle VW, and light rays overlap each other in large proportions, it is possible to reduce the proportions of the overlapping light rays. This allows a light ray incident on the peripheral part 10 to be visually recognized easily by the driver DR in a place included in the peripheral part 10 and located on an upper side in the vertical direction with respect to the rotary part 20 while illuminating a wider place in the peripheral part 10. Furthermore, in comparison to a case where the first optical axis OA1 of the first light illuminator 210 is tilted from the second plane PL2 toward the rightward direction of the vehicle VW, the second optical axis OA2 of the second light illuminator 220 is tilted from the second plane PL2 toward the leftward direction of the vehicle VW, and light rays do not overlap each other, a light ray incident on the peripheral part 10 is visually recognized easily by the driver

DR in a place included in the peripheral part 10 and located on an upper side in the vertical direction with respect to the rotary part 20.

### B. Other Embodiments

### B1. Other Embodiments 1:

(1) In the above-described embodiment, the steering device 1 includes the first light illuminator 210 and the second light illuminator 220 corresponding to a plurality of light illuminators to emit light rays toward the predetermined portion 110. The steering device may include a plurality of light illuminators of a number other than two such as three or five, for example, to emit light rays toward the predetermined portion. In a case where the steering device includes three light illuminators, for example, the steering device may be configured in such a manner that, with respect to one light illuminator at the center, the two light illuminators are symmetric to each other in a rightward-leftward direction of a moving object. The plurality of light illuminators may be configured in such a manner that respective optical axes of light rays from the plurality of light illuminators to emit light rays toward the predetermined portion are included in the same flat plane containing the rightward-leftward direction of the moving object.

(2) In the above-described embodiment, the predetermined portion 110 is a place in the peripheral part 10 located closer to the +Z direction than the axis line AX of the rotary axis AR when the steering device 1 is viewed in the +X direction. The predetermined portion 110 may be located closer to the +Z direction than a position covering the axis line AX of the rotary part 20.

(3) In the above-described embodiment, the steering device 1 is mounted on the vehicle VW. Meanwhile, the steering device may be mounted on a moving object such as a ship or an airplane, for example, other than a vehicle.

(4) In the above-described embodiment, the peripheral part 10 has a substantially ring-like shape when viewed in the X direction. The peripheral part may have a rectangular shape or a trapezoidal shape when viewed in the X direction, for example. The peripheral part may have a substantially rectangular solid shape surrounding the rotary part, for example. As another example, the peripheral part may have a shape with a plurality of rod-like members connected to each other on the Y direction side and the −Z direction side with respect to the rotary part when the rotary part is at the reference angular position. The peripheral part may also be composed of two rod-like members arranged in the +Y direction and the −Y direction respectively with respect to the rotary part when the rotary part is at the reference angular position. The plurality of members of the peripheral part 10 are arranged at least so as to sandwich the rotary axis AR of the rotary part 20.

(5) In the above-described embodiment, the first light illuminator 210 to the fourth light illuminator 240 are configured to be attachable to and detachable from the rotary case unit 250. In a case where the light illuminator is attached with an adhesive to the rotary case unit, for example, the light illuminator may not have to be configured to be attachable to and detachable from the rotary case unit.

(6) In the above-described embodiment, when viewed in the Y direction, the second light illuminator 220 is arranged on the +X direction side with respect to the first plane PL1, which is the same side as the first light illuminator 210. If a part of the light illuminator is overlapping with one plane when viewed in the Y direction, for example, a case where respective optical axes of light rays emitted from a plurality of light illuminators is arranged on the same side with respect to the one plane belongs to a case where each of the plurality of light illuminators are arranged on the same side with respect to the one plane.

### B2. Other Embodiments 2:

(1) In the above-described embodiment, of the respective plurality of light-emitting elements of the first light illuminator 210 and the second light illuminator 220, light-emitting elements to emit light rays of the same color are configured to be symmetric to each other with respect to the second plane PL2. In a case where respective optical axes of light rays from light-emitting elements to emit light rays of the same color are caused to pass through places included in the predetermined portion and located on the same flat plane containing a direction perpendicular to a rotary axis of a moving object and to a rightward-leftward direction of the moving object, and the rightward-leftward direction of the moving object by causing total reflection of a light ray emitted from a light-emitting element and changing the direction of an optical axis of the light ray emitted from the light-emitting element using a lens, for example, the light-emitting elements to emit light rays of the same color may not have to be symmetric to each other with respect to the second plane.

(2) In a case where it is not possible for light-emitting elements to emit light rays of the same color to be arranged symmetric to each other with respect to the second plane depending on a position available for locating the light illuminator, for example, a configuration described next may be employed. Specifically, in this configuration, respective optical axes of the light-emitting elements to emit light rays of the same color are caused to pass through places included in the predetermined portion and located on the same flat plane containing a direction perpendicular to a rotary axis of a moving object and to a rightward-leftward direction of the moving object, and the rightward-leftward direction of the moving object by causing total reflection of a light ray emitted from a light-emitting element and changing the direction of an optical axis of the light ray emitted from the light-emitting element using a lens.

### B3. Other Embodiments 3:

In the above-described embodiment, the light illuminator is configured in such a manner that an optical axis passes through a center of a section at the peripheral part 10 included in the predetermined portion 110 in the peripheral part 10 and on a plane containing the optical axis and the second direction. In a case where an optical axis passes through any place in the predetermined portion in the peripheral part, for example, the light illuminator may not have to be configured in such a manner that the optical axis passes through a center of a section at the peripheral part. In this case, a light ray of higher intensity is incident on the peripheral part than in a case where an optical axis does not pass through the predetermined portion in the peripheral part.

### B4. Other Embodiments 4:

(1) In the above-described embodiment, the steering device 1 includes two light illuminators to emit light rays to the portion 110 in the peripheral part 10 located closer to the +Z direction than the axis line AX of the rotary axis AR when the steering device 1 is viewed in the +X direction. In a case where the peripheral part has a shape with a plurality of rod-like members connected to each other on the Y direction side and the −Z direction side with respect to the rotary part when the rotary part is at the reference angular position, for example, the steering device may include two light illuminators to emit light rays to a portion in the peripheral part located closer to the −Z direction than the axis line of the rotary axis when the steering device is viewed in the +X direction. In this case, the steering device may be configured in such a manner that light rays emitted from the two light illuminators and overlapping each other impinge on a place included in the peripheral part and located on a lower side in the vertical direction with respect to the rotary part when the rotary part is at the reference angular position. This case is believed to allow a driver to move the line of sight easily to a place in the peripheral part located closer to the-Z direction than the axis line of the rotary axis in gripping the steering device. Thus, a light ray incident on the peripheral part becomes visually recognizable easily by the driver by causing the overlapping light rays to impinge on the place included in the peripheral part and located on a lower side in the vertical direction with respect to the rotary part.

(2) The steering device may not have to be configured in such a manner that overlapping light rays impinge on a place included in the peripheral part and located on an upper side in the vertical direction with respect to the rotary part, for example.

### B5. Other Embodiments 5:

(1) In the above-described embodiment, the steering device is configured in such a manner that, when the rotary part 20 is at the reference angular position, the first optical axis OA1 and the second optical axis OA2 are parallel to the second plane PL2.

When the steering device is viewed in the +X direction, the first optical axis may be tilted from the second plane toward the −Y direction and the second optical axis may be tiled from the first plane toward the +Y direction, for example. In this case, a light ray emitted from the first light illuminator and a light ray emitted from the second light illuminator may overlap each other.

(2) For example, the first optical axis may be tilted from the second plane toward the +Y direction and the second optical axis may be tiled from the first plane toward the −Y direction. In this case, a light ray emitted from the first light illuminator and a light ray emitted from the second light illuminator may overlap each other.

The present disclosure is not limited to the embodiments described above and is able to be realized with various configurations without departing from the spirit thereof. For example, technical features in the embodiments corresponding to the technical features in the aspects described in the section of SUMMARY are able to be replaced with each other or combined together as necessary in order to solve part or the whole of the problems described previously or to achieve part or the whole of the effects described previously. When the technical features are not described as essential features in the present specification, they are able to be deleted as necessary.

### B6. Other Embodiments 6:

The present disclosure is feasible in the following aspects.

(1) According to one aspect of the present disclosure, a steering device provided in a moving object is provided. The steering device comprises: a rotary part rotatably attached to the moving object; and a peripheral part arranged at least on both sides of a rotary axis of the rotary part. The peripheral part is connected to the rotary part. The rotary part includes a plurality of light illuminators to emit light rays toward a predetermined portion in the peripheral part. The plurality of light illuminators is configured in such a manner that respective optical axes of light rays emitted from the plurality of light illuminators pass through places included in the predetermined portion and located on one plane containing a perpendicular direction and a rightward-leftward direction of the moving object. The perpendicular direction is perpendicular to a rotary axis direction as a direction along the rotary axis of the moving object and to the rightward-leftward direction of the moving object. When viewed in the rightward-leftward direction of the moving object, all the plurality of light illuminators are arranged on the same side with respect to the plane.

In the steering device of this aspect, a light ray emitted from each of the plurality of light illuminators is incident on a place in the peripheral part located in a predetermined direction with respect to the rotary part. The plurality of light illuminators is configured in such a manner that the respective optical axes of the plurality of light illuminators pass through places included in the predetermined portion and located on the one plane containing the perpendicular direction and the rightward-leftward direction of the moving object. When viewed in the rightward-leftward direction of the moving object, all the plurality of light illuminators are arranged on the same side with respect to the plane. Thus, in comparison to a case where the respective optical axes of the plurality of light illuminators do not pass through places located on one plane containing a direction perpendicular to the rotary axis of the moving object and to the rightward-leftward direction of the moving object, and the rightward-leftward direction of the moving object, or a case where one light illuminator is arranged on the right side with respect to the one plane and another light illuminator is arranged on the left side with respect to the one plane when viewed in the rightward-leftward direction of the moving object, for example, it is possible to reduce non-uniformity in brightness at the peripheral part visually recognized when a passenger sees the steering device in the rotary axis direction.

(2) In the steering device according to the above aspect, the steering device may comprise two light illuminators as the plurality of light illuminators, each of the two light illuminators may include a plurality of light-emitting elements to emit light rays of different colors, and the two light illuminators may be arranged in such a manner that, of the respective plurality of light-emitting elements of the two light illuminators, light-emitting elements to emit light rays of the same color are symmetric to each other with respect to a plane containing the rotary axis direction and the perpendicular direction when the rotary part is at a reference angular position.

(3) In the steering device according to the above aspect, with a direction in which the predetermined portion in the peripheral part extends defined as a first direction and a direction perpendicular to each of the optical axes and to the first direction defined as a second direction, the steering device may be configured in such a manner that the optical axis passes through a center of a section at the peripheral part on a plane containing the optical axis and the second direction.

Generally, the dimension of the peripheral part of the steering device is smaller in a forward-backward direction of the moving object than in the rightward-leftward direction of the moving object. For this reason, it is probable that, if a light ray is emitted to the peripheral part from a light illuminator capable of illuminating the peripheral part in a certain range or more in the rightward-leftward direction of the moving object, the light ray will pass through space outside the peripheral part in terms of a direction parallel to the rotary axis viewed in a forward-backward direction of the peripheral part. Furthermore, it is generally believed that intensity of each portion of a light ray becomes higher as the portion gets closer to an optical axis and becomes lower as the portion gets farther from the optical axis. Hence, passing of a light ray close to an optical axis through the peripheral part may cause a situation where the light ray emitted from the light illuminator will not be used efficiently. In the steering device of this aspect, an optical axis passes through a center of a section at the peripheral part on the plane containing the optical axis and the second direction. By doing so, when viewed in the forward-backward direction of the peripheral part, a light ray of high intensity is incident on the peripheral part efficiently. This makes it possible to efficiently use a light ray emitted from the light illuminator.

(4) In the steering device according to the above aspect, the steering device may comprise two light illuminators as the plurality of light illuminators, and the two light illuminators may be configured in such a manner that: parts of respective light rays emitted from the two light illuminators overlap each other; and the overlapping light rays impinge on a place included in the peripheral part and located on an upper side in a vertical direction with respect to the rotary part when the rotary part is at a reference angular position.

In the steering device of this aspect, the two light illuminators are configured in such a manner that the overlapping light rays impinge on a place included in the peripheral part and located on an upper side in the vertical direction with respect to the rotary part. Thus, a light ray incident on the peripheral part is visually recognized easily by a passenger.

(5) In the steering device according to the above aspect, the steering device may be configured in such a manner that respective optical axes of the light rays emitted from the two light illuminators are parallel to a plane containing the rotary axis direction and the perpendicular direction when the rotary part is at the reference angular position.

In the steering device of this aspect, in comparison to a case where the optical axis of the light ray from the light illuminator of the two light illuminators located in a rightward direction of the moving object is tilted from a plane perpendicular to the rightward-leftward direction of the moving object toward the rightward direction of the moving object and the optical axis of the light ray from the other light illuminator is tilted from the plane perpendicular to the rightward-leftward direction of the moving object toward a leftward direction of the moving object, proportions of overlapping light rays are increased. Thus, in the steering device of this aspect, in comparison to a configuration where the respective optical axes are not parallel to the plane containing the rotary axis direction and the perpendicular direction, a light ray incident on the peripheral part is visually recognized easily by a passenger in a place included in the peripheral part and located on an upper side in the vertical direction with respect to the rotary part. Furthermore, in comparison to a case where the optical axis of the light illuminator of the two light illuminators located in the rightward direction of the moving object is tilted from the plane perpendicular to the rightward-leftward direction of the moving object toward the leftward direction of the moving object, the optical axis of the other light illuminator is tilted from the plane perpendicular to the rightward-leftward direction of the moving object toward the rightward direction of the moving object, and the light rays do not overlap each other, a light ray incident on the peripheral part is visually recognized easily by the passenger in a place included in the peripheral part and located on an upper side in the vertical direction with respect to the rotary part.

The present disclosure is feasible in various aspects other than the steering device. For example, the present disclosure is feasible in aspects including a method of manufacturing a steering device, a vehicle mounted with a steering device, and others.

What is claimed is:

1. A steering device provided in a moving object comprising:
a rotary part rotatably attached to the moving object; and
a peripheral part arranged at least on both sides of a rotary axis of the rotary part, the peripheral part being connected to the rotary part, wherein
the rotary part includes a plurality of light illuminators to emit light rays toward a predetermined portion in the peripheral part,
the plurality of light illuminators is configured in such a manner that respective optical axes of light rays emitted from the plurality of light illuminators pass through places included in the predetermined portion and located on one plane containing a perpendicular direction and a rightward-leftward direction of the moving object, the perpendicular direction being perpendicular (i) to a rotary axis direction as a direction along the rotary axis of the moving object and (ii) to the rightward-leftward direction of the moving object, and
when viewed in the rightward-leftward direction of the moving object, all the plurality of light illuminators are arranged on the same side with respect to the plane.

2. The steering device according to claim 1, wherein
the steering device comprises two light illuminators as the plurality of light illuminators,
each of the two light illuminators includes a plurality of light-emitting elements to emit light rays of different colors, and
the two light illuminators are arranged in such a manner that, of the respective plurality of light-emitting elements of the two light illuminators, light-emitting elements to emit light rays of the same color are symmetric to each other with respect to a plane containing the rotary axis direction and the perpendicular direction when the rotary part is at a reference angular position.

3. The steering device according to claim 1, wherein
with a direction in which the predetermined portion in the peripheral part extends defined as a first direction and a direction perpendicular to each of the optical axes and to the first direction defined as a second direction,
the steering device is configured in such a manner that the optical axis passes through a center of a section at the peripheral part on a plane containing the optical axis and the second direction.

4. The steering device according to claim 1, wherein
the steering device comprises two light illuminators as the plurality of light illuminators, and
the two light illuminators are configured in such a manner that:
parts of respective light rays emitted from the two light illuminators overlap each other; and
the overlapping light rays impinge on a place included in the peripheral part and located on an upper side in a vertical direction with respect to the rotary part when the rotary part is at a reference angular position.

5. The steering device according to claim 4, wherein
the steering device is configured in such a manner that respective optical axes of the light rays emitted from the two light illuminators are parallel to a plane containing the rotary axis direction and the perpendicular direction when the rotary part is at the reference angular position.
